(19) United States
(12) Patent Application Publication
(10) Pub. No.: US 2026/0253908 A1
(43) Pub. Date: Aug. 27, 2026

(54) SECONDARY BATTERY ELECTRODE AND SECONDARY BATTERY

(71) Applicant: Panasonic Energy Co., Ltd., Moriguchi-shi, Osaka (JP)

(72) Inventors: Takeshi Chiba, OSAKA FU (JP); Tetsu Hashimoto, OSAKA FU (JP); Takuma Kishi, HYOGO KEN (JP); Yuki Nakai, NARA KEN (JP)

(73) Assignee: Panasonic Energy Co., Ltd., Moriguchi-shi, Osaka (JP)

(21) Appl. No.: 19/160,154

(22) PCT Filed: Feb. 28, 2024
(86) PCT No.: PCT/JP2024/007388

§ 371 Date: Aug. 27, 2025

(30) Foreign Application Priority Data
Feb. 28, 2023 (JP) 2023-030404

(51) Int. Cl. H01M 4/70; H01M 4/66; H01M 50/107; H01M 50/119

(52) U.S. Cl. CPC H01M 4/70; H01M 4/661; H01M 50/107; H01M 50/119

(57) ABSTRACT

An electrode for secondary batteries includes a band-shaped electrode current collector and an electrode mixture layer provided on the electrode current collector. The electrode has a first electrode edge portion including one edge of the electrode in the short-side direction, a second electrode edge portion including the other edge of the electrode in the short-side direction, and an electrode central portion other than the first electrode edge portion and the second electrode edge portion. The tensile strengths of the first electrode edge portion and the second electrode edge portion each are 100 MPa or less. The tensile strength of the electrode central portion is 150 MPa or more.

### TECHNICAL FIELD

The present disclosure relates to an electrode for secondary batteries and a secondary battery.

### BACKGROUND ART

Secondary batteries include a set of a wound electrode group and an electrolyte as a power generation element. The electrode group is formed by winding a pair of band-shaped electrodes and a separator between the paired electrodes. At least one of the paired electrodes includes a band-shaped electrode current collector and an electrode mixture layer carried on the electrode current collector.

Patent Literature 1 proposes “an electrochemical device including: a positive electrode including a positive electrode core member and a positive electrode material layer carried on the positive electrode core member; a negative electrode including a negative electrode core member and a negative electrode material layer carried on the negative electrode core member; a separator provided between the positive electrode and the negative electrode; a nonaqueous electrolyte; a positive electrode current collector plate electrically connected to the positive electrode core member; and a negative electrode current collector plate electrically connected to the negative electrode core member, wherein the positive electrode, the negative electrode, and the separator constitute a columnar wound body that has a positive electrode core member exposed portion at an edge along the long-side direction of the positive electrode core member, and a negative electrode core material exposed portion at an edge along the long-side direction of the negative electrode core member, the positive electrode core member exposed portion protrudes from one of the end surfaces of the wound body and is welded to the positive electrode current collector plate, the negative electrode core member exposed portion protrudes from the other end surface of the wound body and is welded to the negative electrode current collector, and the thickness of the positive electrode core member is larger than the thickness of the negative electrode core member”.

### CITATION LIST

### Patent Literature

Patent Literature 1: International Publication No. 2020/045375

### SUMMARY OF INVENTION

### Technical Problem

In forming an electrode group, the electrodes are wound while applying a constant tension to the electrodes in order to ensure dimensional accuracy. Due to the tension being applied to the electrodes, a crack may occur, starting from an edge of either of the electrodes in the short-side direction, leading to breakage of the electrode.

In addition, the dimension of the electrodes may change greatly with expansion and contraction of the electrode mixture layer in charging and discharging.

### Solution to Problem

One aspect of the present disclosure relates to an electrode for secondary batteries including: an electrode current collector having a band shape; and an electrode mixture layer provided on the electrode current collector, wherein the electrode has a first electrode edge portion including one edge of the electrode in a short-side direction, a second electrode edge portion including another edge of the electrode in the short-side direction, and an electrode central portion other than the first electrode edge portion and the second electrode edge portion, tensile strengths of the first electrode edge portion and the second electrode edge portion each are 100 MPa or less, and a tensile strength of the electrode central portion is 150 MPa or more.

Another aspect of the present disclosure relates to a secondary battery including: a power generation element, wherein the power generation element includes paired electrodes, a separator, and an electrolyte, the paired electrodes are wound with the separator therebetween, and at least one of the paired electrodes is the aforementioned electrode for secondary batteries.

### Advantageous Effects of Invention

According to the present disclosure, suppression of breakage of the electrodes in winding and suppression of dimensional change of the electrodes in charging and discharging can be achieved at the same time.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic cross-sectional view of a secondary battery according to one example of an embodiment.

FIG. 2 is a schematic plan view of a positive electrode of the secondary battery in FIG. 1.

FIG. 3 is a schematic plan view of a negative electrode of the secondary battery in FIG. 1.

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B and can be phrased as “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one type of them may be selected and used singly, or two or more types of them may be used in combination.

### [Electrode for Secondary Batteries]

An electrode for secondary batteries according to an embodiment of the present disclosure includes an electrode current collector having a band shape and an electrode mixture layer provided on the electrode current collector. The electrode has a first electrode edge portion including one of the edges of the electrode in the short-side direction, a second electrode edge portion including the other edge of the electrode in the short-side direction, and an electrode central portion other than the first electrode edge portion and the second electrode edge portion. The tensile strengths of the first electrode edge portion and the second electrode edge portion are each 100 MPa or less. The tensile strength of the electrode central portion is 150 MPa or more. As for the common matters between the first electrode edge portion and the second electrode edge portion, each of the portions may also be referred to simply as “electrode edge portion”. The electrode for secondary batteries is used in a wound electrode group. The electrode for secondary batteries may be a positive electrode or a negative electrode.

As a method for suppressing the occurrence of cracks due to the tension applied to the electrode in winding, which starts from an edge of the electrode in the short-side direction, it is conceivable to increase the thickness or the flexibility of the electrode current collector. However, when the thickness of the electrode current collector is increased, the energy density is reduced, which is disadvantageous in terms of capacity increase. Further, when the flexibility of the entire electrode current collector is increased, dimensional change of the electrode in charging and discharging becomes large, leading to a possibility that an internal short circuit occurs.

To address the above, in the present disclosure, the tensile strength of each of the edge portions is set to 100 MPa or less. As a result, the flexibility (elongation) of the edge portion of the electrode in the short-side direction is increased to suppress the occurrence of cracks due to the tension applied to the electrode in forming the wound electrode group, starting from an edge of the electrode in the short-side direction, thereby suppressing breakage of the electrode due to the occurrence of the crack.

Furthermore, in the present disclosure, the tensile strength of the electrode central portion is set to 150 MPa or more. As a result, deformation (dimensional change) of the electrode in charging and discharging is suppressed to reduce dimensional change of the electrode in the short-side direction (axial direction of the electrode group).

As described above, as a result of the tensile strengths of the electrode central portion and the electrode edge portions being set to within the respective specified ranges, suppression of breakage of the electrode in winding and suppression of dimensional change of the electrode in charging and discharging can be achieved at the same time. By moderately increasing the flexibility only of the electrode edge portions, breakage of the electrode is effectively suppressed while suppressing dimensional change of the electrode in charging and discharging. In addition, since the thickness of the current collector does not need to be increased, a high energy density can be ensured. When the electrode current collector is an aluminum foil or an aluminum alloy foil, breakage of the electrode in winding and dimensional change of the electrode in charging and discharging are likely to occur. Accordingly, the advantages described above can be obtained remarkably by setting the tensile strengths of the electrode central portion and the electrode edge portions within the specified ranges. The aluminum foil or the aluminum alloy foil is used as the positive electrode current collector, for example.

Note that the tensile strengths of the electrode edge portions reflect the tensile strength of the electrode current collector in the electrode edge portions and can also be said to be the tensile strength of the electrode current collector in the electrode edge portions. The tensile strength of the electrode central portion reflects the tensile strength of the electrode current collector in the electrode central portion and can also be said to be the tensile strength of the electrode current collector in the electrode central portion.

The tensile strength of each electrode edge portion can be determined by a tensile test in accordance with JIS Z 2241. Specifically, a strip-shaped sample piece of a predetermined size is taken from an electrode edge portion. The sample piece measures 120 mm in length and 8 mm in width, for example. The sample piece is sampled so that the longitudinal direction of the sample piece and the longitudinal direction of the electrode substantially coincide with each other. The sample piece is tensioned in the longitudinal direction at a cross-head displacement rate of 5 mm/min, and the maximum stress of the sample piece at the time just before breakage is determined as the tensile strength. The tensile strength of the electrode central portion can also be determined in the same manner as that of the electrode edge portions. In the case in which either electrode edge portion has a current collector exposed portion at a part thereof, the sample piece is taken from a part (electrode mixture portion) other than the current collector exposed portion. When the entirety of the electrode edge portion is the current collector exposed portion, the sample piece is taken from the current collector exposed portion.

From the viewpoint of suppressing breakage of the electrode, the tensile strengths of the electrode edge portions are each preferably 90 MPa or less, and more preferably 85 MPa or less. From the viewpoint of ensuring the strength of the entire electrode, the tensile strengths of the electrode edge portions may be 50 MPa or more or 60 MPa or more.

The tensile strengths of the first electrode edge portion and the second electrode edge portion may differ from each other in any of the above-described ranges but are preferably almost equal to each other. The phrase “almost equal to each other” as used herein means that a ratio: T1/T2 of a tensile strength T1 of the first electrode edge portion to a tensile strength T2 of the second electrode edge portion is in the range of 9/11 to 11/9, inclusive. T1/T2 may be 19/21 or more and 21/19 or less.

The tensile strength of the electrode central portion is preferably 160 MPa or more. In addition, from the viewpoint of ensuring the winding flexibility of the electrode, the tensile strength of the electrode central portion may be 250 MPa or less, for example.

From the viewpoint of suppressing the breakage of the electrode, the elongations at break of the first electrode edge portion and the second electrode edge portion are each preferably 5% or more. The elongation at break of each of the electrode edge portions reflects the elongation at break of the electrode current collector in the electrode edge portion and can also be referred to as the elongation at break of the electrode current collector in the electrode edge portion.

Within any of the above ranges, the elongations at break of the first electrode edge portion and the second electrode edge portion may differ from each other but are preferably almost equal to each other. The phrase “almost equal to each other” as used herein means that a ratio: S1/S2 of an elongation Si at break of the first electrode edge portion to an elongation S2 at break of the second electrode edge portion is in the range of 9/11 to 11/9, inclusive. S1/S2 may be 19/21 or more and 21/19 or less.

The widths (lengths in the short-side direction) of the first electrode edge portion and the second electrode edge portion are each preferably 8 mm or more and 12 mm or less. Within the above range, the widths of the first electrode edge portion and the second electrode edge portion may differ from each other but are preferably almost equal to each other. The phrase “almost equal to each other” as used herein means that a ratio: W1/W2 of a width W1 of the first electrode edge portion to a width W2 of the second electrode edge portion is in the range of 9/11 to 11/9, inclusive. W1/W2 may be 19/21 or more and 21/19 or less.

A ratio: W1/W3 of the width W1 (length in the short-side direction) of the first electrode edge portion to a width W3 (length in the short-side direction) of the electrode central portion may be, for example, in the range of 1/11 to 3/7, or may be in the range of 2/11 to 1/3. A ratio: W2/W3 of a width W2 (length in the short-side direction) of the second electrode edge portion to the width W3 (length in the short-side direction) of the electrode central portion may be, for example, in the range of 1/11 to 3/7, or may be in the range of 2/11 to 1/3. When W1/W3 and W2/W3 are within the above ranges, advantages resulting from the tensile strengths of the electrode central portion and the electrode edge portions being set to the specified ranges can be easily obtained in a well-balanced manner.

The elongation at break of each electrode edge portion can be determined in accordance with JIS Z 2241. Specifically, a tensile test using a sample piece is performed in the same manner as that for determining the tensile strength described above to determine, as an elongation at break, a rate (percentage) of the difference between the gage length of the sample piece measured at the time of break and the gage length thereof before the test to the gage length thereof before the test.

The first electrode edge portion or the second electrode edge portion may have an exposed portion of the electrode current collector provided along the long-side direction of the electrode. The exposed portion may be provided continuously along the long-side direction of the electrode or may be intermittently provided at a plurality of locations along the long-side direction of the electrode. The exposed portion is provided from one edge or the other edge of the electrode in the short-side direction toward the electrode central portion.

The edge of the electrode in the short-side direction having the exposed portion of the electrode current collector is low in mechanical strength, and the stress when tension is applied in the longitudinal direction is unevenly distributed in the short-side direction. This tends to cause cracking in the electrode, starting from the edge, in formation of the electrode group. Therefore, the cracking suppression effect obtained by setting the tensile strengths at the electrode edge portions to 100 MPa or less is remarkable. A ratio: WE/W of a width (length in the short-side direction) WE of the exposed portion of the electrode current collector to a width (length in the short-side direction) W of the corresponding electrode edge portion is 0.05 or more and 1 or less, for example.

The tensile strength of the electrode central portion can be adjusted by appropriately selecting the material and thickness of the base material (metal foil) used for the electrode current collector. The tensile strength of each electrode edge portion can be adjusted, for example, by heat-treating the electrode edge portion (electrode current collector in the electrode edge portion) at a predetermined temperature.

The following describes an example of a method of producing the electrode.

First, a metal foil (or an alloy foil) having a tensile strength of 150 MPa or more is prepared as an electrode current collector to which an electrode slurry is to be applied. The tensile strength can be adjusted according to the material and thickness of the metal foil. As the electrode current collector, an aluminum foil or an aluminum alloy foil having a thickness of 5 to 20 μm can be used, for example. An electrode slurry containing an electrode mixture and a dispersion medium is applied to a surface of the metal foil and dried to form an electrode mixture layer. In the manner described above, an electrode mixture portion in which the electrode mixture layer is formed on the surface of the electrode current collector is formed. Thereafter, the electrode mixture portion may be rolled using a roller. Thereafter, only the electrode edge portions are passed between a pair of heat rollers for heat treatment. As a result, the tensile strengths of the electrode edge portions (electrode current collector in the electrode edge portions) can be reduced to 100 MPa or less (further, the elongation at break of the electrode edge portions can be increased to 5% or more). The tensile strengths and elongations at break of the electrode edge portions can be adjusted according to the heat treatment temperature. The exposed portion of the electrode current collector may be formed by not applying the electrode slurry to a part of the electrode current collector or may be formed by scraping off a part of the electrode mixture layer. The electrode mixture layer contains at least an electrode active material.

A secondary battery according to an embodiment of the present disclosure includes a power generation element, and the power generation element includes paired band-shaped electrodes, a separator, and an electrolyte. One of the paired band-shaped electrodes is a band-shaped positive electrode, and the other of the paired band-shaped electrodes is a band-shaped negative electrode. The paired electrodes (positive electrode and negative electrode) are wound with the separator therebetween. That is, the secondary battery includes a wound electrode group. The outer shape of the wound electrode group is columnar and may be, for example, cylindrical. At least one of the paired electrodes is the electrode for secondary batteries according to the present disclosure.

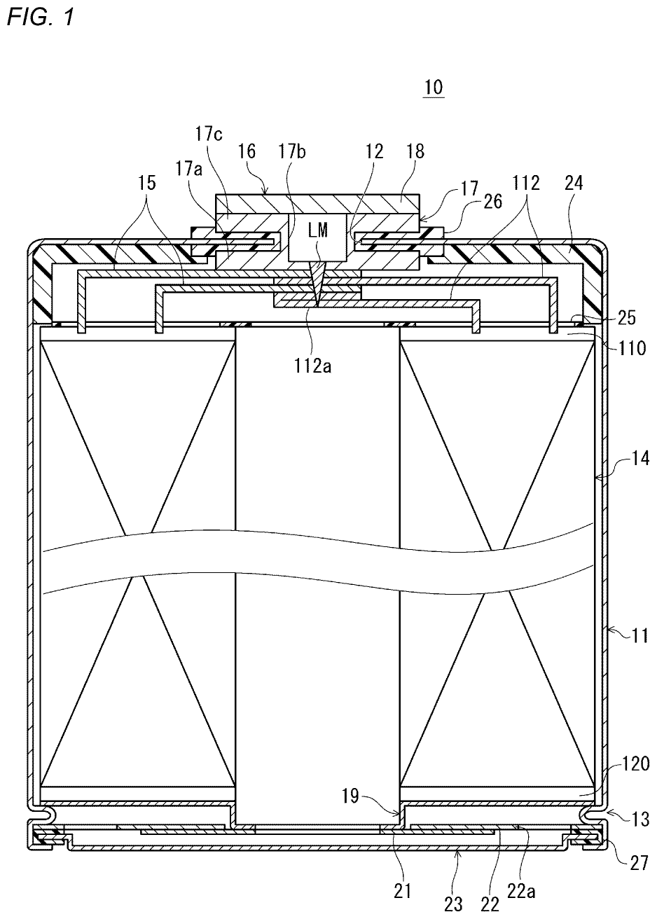

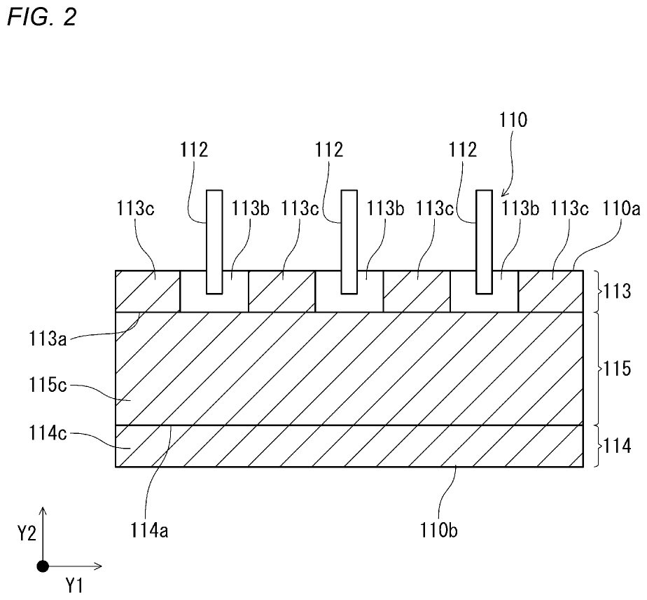

The secondary battery includes, for example, a metal case in the form of a bottomed cylinder that houses the power generating element. The outer diameter of the metal case may be 25 mm or more. A large-diameter cylindrical secondary battery having an outer diameter of 25 mm or more includes a cylindrical electrode group having a large diameter. An example of such a secondary battery is a secondary battery having the configuration illustrated in FIG. 1. In forming a large-diameter electrode group, the electrodes are wound while applying a large tension to the electrodes in order to ensure dimensional accuracy. This is likely to cause a break of either electrode in winding, starting from an edge of the electrode in the short-side edge direction. Therefore, a remarkable effect of suppression of electrode breakage through setting the tensile strengths of the electrode edge portions to 100 MPa or less can be obtained. In particular, with the positive electrode as illustrated in FIG. 2, which has the exposed portion of the positive electrode current collector at a plurality of locations, remarkable effects by setting the tensile strengths of the positive electrode edge portions to 100 MPa or less can be obtained.

The secondary battery includes nonaqueous electrolyte secondary batteries such as lithium-ion secondary batteries, lithium-metal secondary batteries, solid batteries including a gel electrolyte or a solid electrolyte. That is, the secondary battery may be a liquid-type secondary battery including an electrolyte as a liquid electrolyte or an all-solid secondary battery including a solid electrolyte.

Hereinafter, an example of a secondary battery according to an embodiment of the present disclosure will be described in detail with reference to the drawings. The above-described elements of configuration can be applied to the elements of configuration of the example of the secondary battery described below. The elements of configuration of the example of the secondary battery described below can be altered based on the above description. Further, the matters described below may be applied to the above-described embodiments. Among the elements of configuration of the example of the secondary battery described below, an element of configuration that is not essential to the secondary battery according to the present disclosure may be omitted. It should be noted that the drawings indicated below are schematic and do not accurately reflect the shape or number of actual members.

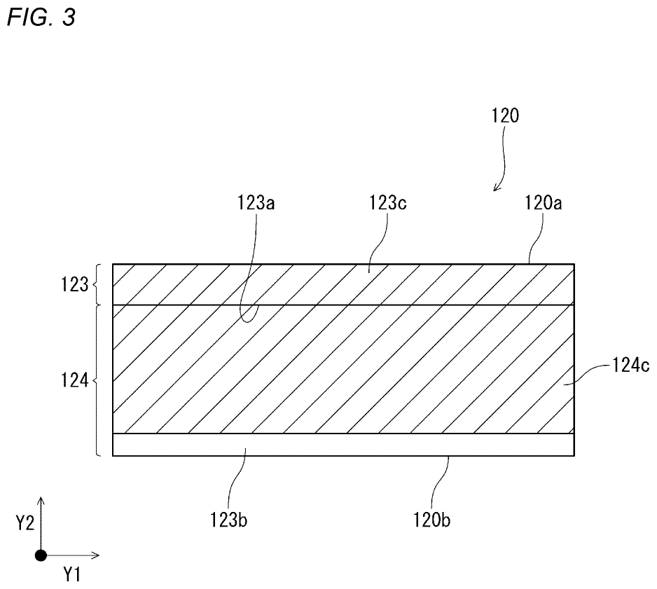

FIG. 1 is a schematic cross-sectional view of a secondary battery 10 according to one example of the present embodiment. FIG. 2 is a schematic plan view of a positive electrode 110 used in the secondary battery 10 of FIG. 1. FIG. 3 is a schematic plan view of a negative electrode 120 used in the secondary battery 10 of FIG. 1. Note that the positive electrode 110 of FIG. 2 indicates an example of the electrode according to an embodiment of the present disclosure, and the electrode according to the present disclosure is not limited thereto.

The secondary battery 10 may be, for example, a lithium-ion secondary battery or a lithium secondary battery (lithium-metal secondary battery). As illustrated in FIG. 1, the secondary battery 10 includes a non-polar case 11, a wound electrode group 14, a plurality of positive electrode leads 112 constituted of conductors, a positive electrode terminal 16 constituted of a conductor, an end face current collector plate 19 constituted of a conductor, a negative electrode current collector plate 22 constituted of a conductor, and a sealing plate 23.

The case 11 is formed to have a bottomed cylindrical shape having an opening at one end (lower end in FIG. 1). The case 11 is constituted of a metal. A through hole 12 through which the positive electrode terminal 16 is inserted is formed in the center of the bottom (upper end in FIG. 1) of the case 11. The case 11 houses a non-illustrated electrolyte together with the electrode group 14. In the vicinity of the opening of the case 11, a recess 13 is formed which is recessed radially inward from the case 11.

The electrode group 14 includes a positive electrode 110 and a negative electrode 120. The electrode group 14 is a wound electrode group formed by winding the positive electrode 110 and the negative electrode 120 with a separator (not illustrated) therebetween. The electrode group 14 is generally cylindrical in shape.

One end of each of the plurality of positive electrode leads 112 is connected to the exposed portion 113b of the positive electrode current collector in a first positive electrode edge portion 113 of the positive electrode 110. The other end of each of the plurality of positive electrode leads 112 is provided so as to stand from one of the end surfaces of the electrode group 14.

The plurality of positive electrode leads 112 are placed in an overlapping manner and connected to the positive electrode terminal 16 by welding. In the present embodiment, the number of the positive electrode leads 112 is eight, but the present invention is not limited thereto. Further, only four of the eight positive electrode leads 112 are illustrated in FIG. 1.

The material of the positive electrode leads 112 is stainless steel, aluminum, an aluminum alloy, nickel, or a nickel alloy, for example.

Between the electrode group 14 and the bottom of the case 11, an insulating member 24 is provided for electrically insulating them. The insulating member 24 is constituted of an insulative resin, for example. The insulating member 24 may be attached to the bottom of the case 11.

The positive electrode terminal 16 is provided opposite the electrode group 14 with the plurality of positive electrode leads 112 therebetween. The positive electrode terminal 16 is inserted through the through hole 12 in the bottom of the case 11 and passes through the bottom of the case 11. The positive electrode terminal 16 is constituted of a metal, and a rivet is used therefor, for example. The positive electrode terminal 16 is insulated from the case 11 by a positive electrode gasket 26 constituted of an insulating material. Between the positive electrode terminal 16 and the electrode group 14, an insulating plate 25 is provided for electrically insulating them.

The positive electrode terminal 16 includes a first terminal member 17 extending in and out of the case 11, and a disk-shaped second terminal member 18 joined to the first terminal member 17 and exposed to the outside of the case 11. The first terminal member 17 includes a disk-shaped first portion 17a, a hollow cylindrical second portion 17b that is formed continuously from the first portion 17a and that is inserted into the through hole 12, and a third portion 17c that extends radially outward from an end of the second portion 17b and to which the second terminal member 18 is joined. The first terminal member 17 is welded at the first portion 17a to the plurality of positive electrode leads 112 by lasers irradiated in the direction from the first terminal member 17 toward the electrode group 14. In the above configuration, the positive electrode terminal 16 is electrically connected to the positive electrode 110 via the plurality of positive electrode leads 112 to function as an external positive electrode terminal of the secondary battery 10. The first terminal member 17 is an example of a terminal member.

One (the lowermost positive electrode lead 112 in FIG. 1) of the plurality of positive electrode leads 112 that is located closest to the electrode group 14 has a folded portion 112a that is formed by folding a part (specifically, a part of the distal end) of the positive electrode lead 112 and in which apart of a laser mark LM formed by the aforementioned lasers is located. The folded portion 112a is located opposite the electrode group 14 with the insulating plate 25 therebetween.

The end face current collector plate 19 is constituted of a metal. The shape of the end face current collector plate 19 is not particularly limited and may be generally cross shaped as a whole, for example. The end face current collector plate 19 is electrically connected to the negative electrode 120 of the electrode group 14.

The negative electrode current collector plate 22 is electrically connected to the end face current collector plate 19 via a metal-made connecting plate 21 (which may be formed to have a ring-like shape, for example). In the above configuration, the negative electrode current collector plate 22 is electrically connected to the negative electrode 120. The negative electrode current collector plate 22 and the connecting plate 21 may be welded (e.g., laser-welded) to each other. The connecting plate 21 and the end face current collector plate 19 may be welded (e.g., laser welded) to each other. The negative electrode current collector plate 22 may be directly connected to the end face current collector plate 19. In this case, the connecting plate 21 is unnecessary. The negative electrode current collector plate 22 has one or more injection holes 22a through which a liquid electrolyte is to be injected into the case 11. The negative electrode current collector plate 22 is welded (e.g., laser-welded) at the outer edge thereof to the recess 13 of the case 11. In the above configuration, the case 11 is electrically connected to the negative electrode 120 via the negative electrode current collector plate 22 and the like.

The sealing plate 23 seals the opening of the case 11. The sealing plate 23 is constituted of a metal and is generally disc shaped. The sealing plate 23 is insulated from the case 11 by a negative electrode gasket 27. The sealing plate 23 of the present embodiment is electrically connected to neither the positive electrode 110 nor the negative electrode 120 of the electrode group 14, but the present disclosure is not limited thereto. The sealing plate 23 includes an explosion-proof mechanism (not illustrated) that is activated upon the internal pressure of the case 11 exceeding a predetermined value.

FIG. 2 illustrates the positive electrode 110 in a state prior to being wound into the electrode group 14. In FIG. 2, an arrow Y1 indicates the winding direction of the positive electrode 110 in forming the electrode group 14 and corresponds to the longitudinal direction of the positive electrode 110. By contrast, an arrow Y2 in FIG. 2, which is perpendicular to the arrow Y1, indicates the winding axis direction of the positive electrode 110 (i.e., the winding axis direction of the electrode group 14) and corresponds to the short-side direction of the positive electrode 110.

As illustrated in FIG. 2, the positive electrode 110 has a first positive electrode edge portion 113 including one edge 110a of the positive electrode 110 in the short-side direction, a second positive electrode edge portion 114 including another edge 110b of the positive electrode 110 in the short-side direction, and a positive electrode central portion 115 other than the first positive electrode edge portion 113 and the second positive electrode edge portion 114. The positive electrode central portion 115 is an area from a positive electrode central-side edge 113a of the first positive electrode edge portion 113 to a positive electrode central-side edge 114a of the second positive electrode edge portion 114. The positive electrode current collector of the positive electrode 110 is made of an aluminum foil or an aluminum-alloy foil, for example.

A ratio: W1/W3 of a width W1 (length in the short-side direction) of the first positive electrode edge portion 113 to a width W3 (length in the short-side direction) of the positive electrode central portion 115 may be, for example, in the range of 1/11 to 3/7, or may be in the range of 2/11 to 1/3. A ratio: W2/W3 of a width W2 (length in the short-side direction) of the second positive electrode edge portion 114 to W3 may also fall within the same range as W1/W3 described above.

The first positive electrode edge portion 113 of the positive electrode 110 has an exposed portion 113b of the positive electrode current collector where a positive electrode mixture layer is not provided on the positive electrode current collector, and a first positive electrode mixture portion 113c where the positive electrode mixture layer is provided on the positive electrode current collector. Also, the second positive electrode edge portion 114 has a second positive electrode mixture portion 114c where the positive electrode mixture layer is provided on the positive electrode current collector. The positive electrode central portion 115 has a third positive electrode mixture portion 115c where the positive electrode mixture layer is provided on the positive electrode current collector.

The exposed portion 113b of the positive electrode current collector is intermittently provided at a plurality of (e.g., eight) locations along the long-side direction of the positive electrode current collector. The exposed portion 113b does not include the positive electrode mixture layer from the one edge 110a of the positive electrode 110 in the short-side direction to the positive electrode central portion 115.

The length of the exposed portion 113b of the positive electrode current collector at each location in the longitudinal direction of the positive electrode current collector may be 1% to 10% of the length of the positive electrode current collector in the longitudinal direction. The total length of the exposed portion 113b of the positive electrode current collector in the longitudinal direction of the positive electrode current collector may be 5% to 30% or 8% to 20% of the length of the positive electrode current collector in the longitudinal direction.

Desirably, the intervals between adjacent locations of the exposed portion 113b of the positive electrode current collector are as equal as possible. For example, given that L represents the length of the positive electrode current collector and n represents the number of locations of the exposed portion 113b of the positive electrode current collector, the intervals between the adjacent locations of the exposed portion 113b of the positive electrode current collector may be 0.8×L/n to 1.2×L/n.

A tab-shaped positive electrode lead 112 is connected to each location of the exposed portion 113b of the positive electrode current collector. The plurality of positive electrode leads 112 are bundled and connected to the first portion 17a of the first terminal member 17.

In the present embodiment, a mass M1 of the positive electrode mixture layer per unit area in the first positive electrode mixture portion 113c may be substantially the same as a mass M3 of the positive electrode mixture layer per unit area in the third positive electrode mixture portion 115c. The proportion of a difference (ΔM) between M1 and M3 to M1 may be, for example, 4% or less, or may be 3% or less. As for M1 described above, the same can be said for a mass M2 of the positive electrode mixture layer per unit area in the second positive electrode mixture portion 114c.

As illustrated in FIG. 3, the negative electrode 120 has a negative electrode edge portion 123 including one edge 120a of the negative electrode 120 in the short-side direction, and a negative electrode main portion 124 other than the negative electrode edge portion 123. The negative electrode edge portion 123 faces the first positive electrode edge portion 113. The negative electrode main portion 124 faces the positive electrode main portion (the second positive electrode edge portion 114 and the positive electrode central portion 115). The negative electrode main portion 124 is an area from a negative electrode center-side edge 123a of the negative electrode edge portion 123 to another edge 120b of the negative electrode 120 in the short-side direction. The ratio between the width (length in the short-side direction) of the negative electrode edge portion 123 and the width (length in the short-side direction) of the negative electrode main portion 124 is, for example, in the range of 1:15 to 3:4 or 1:12 to 1:7.

The negative electrode 120 has, at the other edge 120b thereof in the short-side direction, an exposed portion 123b of a negative electrode current collector where the negative electrode mixture layer is not provided on the negative electrode current collector. The exposed portion 123b of the negative electrode current collector is formed along the long-side direction of the negative electrode current collector. In the above configuration, the exposed portion 123b of the negative electrode current collector is exposed at the other end surface of the electrode group 14. The exposed portion 123b of the negative electrode current collector is connected to the end face current collector plate 19, for example, by laser welding.

The negative electrode edge portion 123 may be a first negative electrode edge portion having a tensile strength of 100 MPa or less. The exposed portion 123b of the negative electrode current collector may be a second negative electrode edge portion having a tensile strength of 100 MPa or less. Apart of the negative electrode main portion 124 other than the exposed portion 123b of the negative electrode current collector may be a negative electrode central portion having a tensile strength of 150 MPa or more.

Hereinafter, each element of configuration of the secondary battery will be described in detail.

### [Positive Electrode]

The positive electrode includes a band-shaped positive electrode current collector and a positive electrode mixture layer provided on the positive electrode current collector. The positive electrode mixture layer may be film. The positive electrode includes a positive electrode current collector and a positive electrode mixture layer formed (or carried) on the entirety or a partial area of a surface of the positive electrode current collector.

The positive electrode mixture layer is constituted of a positive electrode mixture. Since the positive electrode mixture contains a positive electrode active material as an essential component, the positive electrode mixture layer may be referred to as positive electrode active material layer. The positive electrode mixture layer is carried on one or both surfaces of the positive electrode current collector.

The positive electrode mixture contains a positive electrode active material as an essential component, and may contain, for example, a binder, a conductive aid, and a thickener as optional components. The positive electrode active material may be a material that reversibly absorbs and releases lithium ions. The positive electrode active material may be a lithium-containing transition metal oxide, for example. Typical examples of the lithium-containing transition metal oxide include lithium cobaltate and lithium nickelate each having a layered rock-salt type crystal structure.

The positive electrode mixture layer can be formed, for example, by applying a positive electrode slurry to a surface of the positive electrode current collector and drying the slurry. Here, a positive electrode mixture containing particles of the positive electrode active material, which is an essential component, and optional components (e.g., a binder and a conductive aid) is dispersed in a dispersing medium in the positive electrode slurry. The applied film after drying may be rolled, if necessary. The positive electrode mixture layer may be formed on one surface of the positive electrode current collector or may be formed on both surfaces. As the dispersion medium of the positive electrode slurry, N-methyl-2-pyrrolidone (NMP) is used, for example.

As the positive electrode active material, a composite oxide containing lithium and a transition metal such as Ni, Co, or Mn can be used, for example. Examples thereof include LiₐCoO₂, LiₐNiO₂, LiₐMnO₂, LiₐCo_{b}Ni_{1-b}O₂, LiaCO_{b}M_{1-b}O_{c}, LiₐNi_{1-b}M_{b}O_{c}, LiₐMn₂O₄, LiₐMn_{2-b}M_{b}O₄, LiMPO₄, Li₂MPO₄F (M is at least one selected from the group consisting of Na, Mg, Sc, Y, Mn, Fe, Co, Ni, Cu, Zn, Al, Cr, Pb, Sb, and B). Here, 0<a≤1.2, 0<b≤0.9, and 2.0≤c≤2.3. Note that the value “a” indicating the molar ratio of lithium is increased or decreased by charging or discharging.

Among them, a lithium-nickel composite oxide represented by LiₐNi_{b}Me_{1-b}O₂ (Me is at least one selected from the group consisting of Mn, Co, and Al, 0<a≤1.2, and 0.3≤b<1) is preferable. From the viewpoint of capacity increase, it is more preferable to satisfy 0.85≤b<1. From the viewpoint of crystal structure stabilization, LiₐNi_{b}Co_{c}Al_{d}O₂ containing Co and Al each as Me(0<a≤1.2, 0.85≤b<1, 0<c<0.15, 0<d≤0.1, b+c+d=1) is further preferable.

Examples of the binder include resin materials such as: fluorocarbon resins such as polytetrafluoroethylene and polyvinylidene fluoride (PVDF); polyolefin resins such as polyethylene and polypropylene; polyamide resins such as aramid resin; polyimide resins such as polyimide and polyamideimide; acrylic resins such as polyacrylic acid, methyl polyacrylate, and ethylene-acrylic acid copolymers; vinyl resins such as polyacrylonitrile and polyvinyl acetate; polyvinylpyrrolidone; and polyethersulfone. One binder may be used singly, or two or more binders may be used in combination.

Examples of the conductive aid include carbon materials such as graphite, carbon black such as acetylene black, and carbon fibers (carbon nanotubes (CNT) and carbon fibers other than CNT). One conductive aid may be used singly, or two or more conductive aids may be used in combination.

As the positive electrode current collector, a nonporous conductive substrate (e.g., a metal foil) or a porous conductive substrate (e.g., a mesh, a net, or a punched sheet) is used. Examples of the material of the positive electrode current collector include stainless steel, aluminum, aluminum alloys, and titanium. The thickness of the positive electrode current collector is not particularly limited, but is preferably 1 to 50 μm, and more preferably 5 to 20 μm.

### [Negative Electrode]

The negative electrode includes a band-shaped negative electrode current collector. The negative electrode may include the negative electrode current collector and a negative electrode mixture layer or a negative electrode active material layer formed (or carried) on the entirety or a partial area of a surface of the negative electrode current collector. The negative electrode mixture layer or negative electrode active material layer may be film. The negative electrode mixture layer or the negative electrode active material layer is carried on one or both surfaces of the negative electrode current collector.

The negative electrode mixture layer is constituted of a negative electrode mixture. The negative electrode active material layer is constituted of a negative electrode mixture or a negative electrode active material. Since the negative electrode mixture contains a negative electrode active material as an essential component, the negative electrode mixture layer may be referred to as negative electrode active material layer. The negative electrode active material may be a material that reversibly absorbs and releases lithium ions, a lithium metal, or a lithium alloy. A negative electrode active material layer constituted of a material other than the negative electrode mixture is constituted of at least one selected from the group consisting of a lithium metal and a lithium alloy. The negative electrode mixture layer or the negative electrode active material layer is carried on one or both surfaces of the negative electrode current collector.

The negative electrode mixture contains a negative electrode active material as an essential component, and may contain, for example, a binder, a conductive aid, and a thickener as optional components. The negative electrode mixture layer such as above can be formed, for example, by applying a negative electrode slurry to a surface of the negative electrode current collector and drying the slurry. Here, a negative electrode mixture containing particles of the negative electrode active material as an essential component and an optional component is dispersed in a dispersing medium in the negative electrode slurry. The applied film after drying may be rolled, if necessary.

Examples of the negative electrode active material include carbon materials, metal materials such as Si and Sn, alloy materials containing, for example, Si or Sn, metal compounds containing, for example, Si or Sn, and metal oxides containing, for example, lithium. Examples of the metal oxides containing lithium include a spinel-type lithium titanium oxide and a spinel-type lithium manganese oxide.

The carbon material can be graphite, graphitizable carbon (soft carbon), or non-graphitizable carbon (hard carbon), for example. Among these, graphite, which has excellent stability during charging and discharging and low irreversible capacity, is preferable.

Graphite refers to a carbon material having an interplanar spacing d002 of the (002) plane measured by X-ray diffractometry of, for example, 0.340 nm or less. The crystallite size Lc(002) of graphite measured by X-ray diffractometry may be, for example, 5 nm or more, 5 nm or more and 300 nm or less, or 10 nm or more and 200 nm or less.

The negative electrode active material may be a composite material containing Si. The composite material containing Si is suitable as a negative electrode active material due to its high capacity. The composite material includes silicon phases. Silicon can reversibly form an alloy with lithium. The composite material is a material capable of reversibly absorbing and releasing lithium ions.

The composite material includes silicon phases and a matrix phase in which the silicon phases are dispersed. The matrix phase should be constituted of a material having lithium ion conductivity. The matrix phase includes, for example, at least one selected from the group consisting of a silicon oxide phase and a carbon phase.

The silicon oxide phase contains Si and O, and may further contain a third element other than Si and O. The silicon oxide phase may be constituted of SiO₂, lithium silicate, or both. Lithium silicate can be represented by Li_{2y}SiO_{2+y} (0<y<2), for example. A composite material in which the silicon oxide phase is constituted of SiO₂ can be represented by SiOₓ(0.5≤x≤1.6).

When a carbon material and a composite material are used in combination, the proportion of the composite material in the negative electrode active material (total of the carbon material and the composite material) is, for example, 1% by mass or more and 20% by mass or less, and may be 3% by mass or more and 15% by mass or less, or 3% by mass or more and 10% by mass or less. In this case, it is easy to achieve improved cycle characteristics and capacity increase in a well-balanced manner.

Examples of the binder include resin materials such as: fluorocarbon resins such as polytetrafluoroethylene and polyvinylidene fluoride (PVDF); polyolefin resins such as polyethylene and polypropylene; polyamide resins such as aramid resin; polyimide resins such as polyimide and polyamideimide; acrylic resins such as polyacrylic acid, methyl polyacrylate, and ethylene-acrylic acid copolymers; vinyl resins such as polyacrylonitrile and polyvinyl acetate; polyvinylpyrrolidone; polyethersulfone; and rubber-like materials such as styrene-butadiene copolymer rubbers (SBR). One binder may be used singly, or two or more binders may be used in combination.

Examples of the conductive aid include carbons such as acetylene black, carbon fibers (carbon nanotubes (CNT) and carbon fibers other than CNT), metal fibers, and metal powders such as aluminum. One conductive aid may be used singly, or two or more conductive aids may be used in combination.

Examples of the thickener include: cellulose derivatives (e.g., cellulose ethers) such as carboxymethylcellulose (CMC) and modified forms thereof (including salts such as Na salt) and methylcellulose; and saponified products of polymers having a vinyl acetate unit, such as polyvinyl alcohol. One thickener may be used singly, or two or more thickeners may be used in combination.

As the negative electrode current collector, a non-porous conductive substrate (e.g., a metal foil) or a porous conductive substrate (e.g., a mesh, a net, or a punched sheet) is used. Example of the material of the negative electrode current collector include stainless steel, nickel, nickel alloys, copper, and copper alloys. The thickness of the negative electrode current collector is not particularly limited, but is preferably 1 to 50 μm, and more preferably 5 to 20 μm.

### [Electrolyte]

The electrolyte may be a liquid electrolyte (electrolyte liquid), a gel electrolyte, or a solid electrolyte. The liquid electrolyte is, for example, an electrolyte liquid containing a nonaqueous solvent and a salt dissolved in the nonaqueous solvent. The concentration of the salt in the electrolyte liquid is 0.5 μmol/L or more and 2 μmol/L or less, for example. The electrolyte liquid may contain a known additive.

The gel electrolyte contains a salt and a matrix polymer, or contains a salt, a nonaqueous solvent, and a matrix polymer. As the matrix polymer, a polymer material that absorbs a nonaqueous solvent to gel is used, for example. Examples of the polymer material include fluorocarbon resins, acrylic resins, polyether resins, and polyethylene oxides.

As the solid electrolyte, a material (e.g., an oxide-based solid electrolyte, a sulfide-based solid electrolyte, or a halide-based solid electrolyte) known in the fields of all-solid lithium-ion secondary batteries and the like is used, for example.

For example, a nonaqueous electrolyte in the liquid state is prepared by dissolving a salt in a nonaqueous solvent. The salt is an electrolyte salt that ionically dissociates in an electrolyte, and can include, for example, a lithium salt. The electrolyte can contain various additives. The electrolyte is usually used in the liquid state as is, but its fluidity may be restricted by a gelling agent or the like.

Examples of the nonaqueous solvent that can be used include cyclic carbonic acid esters, chain carbonic acid esters, cyclic carboxylic acid esters, and chain carboxylic acid esters. Examples of the cyclic carbonic acid esters include propylene carbonate (PC) and ethylene carbonate (EC). A cyclic carbonic acid ester having an unsaturated bond, such as vinylene carbonate (VC) may be used. A cyclic carbonic acid ester having a fluorine atom, such as fluoroethylene carbonate (FEC) may be used. Examples of the chain carbonic acid esters include diethyl carbonate (DEC), ethyl methyl carbonate (EMC), and dimethyl carbonate (DMC). Examples of the cyclic carboxylic acid esters include γ-butyrolactone (GBL) and γ-valerolactone (GVL). Examples of the chain carboxylic acid esters include methyl formate, ethyl formate, propyl formate, methyl acetate, ethyl acetate, propyl acetate, methyl propionate, ethyl propionate, and propyl propionate. One nonaqueous solvent may be used singly, or two or more nonaqueous solvents may be used in combination.

Examples of the lithium salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylates, LiCl, LiBr, LiI, borates, and imide salts. Examples of the borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-oleate-1-benzenesulfonate-O,O′) borate. Examples of the imide salts include lithium bis(fluorosulfonyl)imide (LiN(FSO₂)₂), lithium bis(trifluoromethanesulfonate)imide (LiN(CF₃SO₂)₂), lithium (trifluoromethanesulfonate)(nonafluorobutanesulfonate)imide (LiN (CF₃SO₂)(C₄F₉SO₂)), and lithium bis(pentafluoroethanesulfonate)imide (LiN(C₂F₅SO₂)₂). One lithium salt may be used singly, or two or more lithium salts may be used in combination. The concentration of the lithium salt in the nonaqueous electrolyte is 0.5 mol/L or more and 2 mol/L or less, for example.

### [Separator]

It is desirable to provide the separator between the positive electrode and the negative electrode. The separator is excellent in ion permeability and has moderate mechanical strength and insulating properties. As the separator, a microporous thin film, a woven fabric, or a nonwoven fabric can be used, for example. As the material of the separator, a polyolefin such as polypropylene or polyethylene is preferable.

### (Supplemental Remarks)

According to the above description, the following techniques are disclosed.

### (Technique 1)

An electrode for secondary batteries including:
an electrode current collector having a band shape; and an electrode mixture layer provided on the electrode current collector,
wherein the electrode has a first electrode edge portion including one edge of the electrode in a short-side direction, a second electrode edge portion including another edge of the electrode in the short-side direction, and an electrode central portion other than the first electrode edge portion and the second electrode edge portion,
tensile strengths of the first electrode edge portion and the second electrode edge portion each are 100 MPa or less, and
a tensile strength of the electrode central portion is 150 MPa or more.

### (Technique 2)

The electrode for secondary batteries according to Technique 1, wherein the first electrode edge portion or the second electrode edge portion has an exposed portion of the electrode current collector intermittently provided at a plurality of locations along a long-side direction of the electrode, and
the exposed portion is provided from one edge or the other edge of the electrode in the short-side direction toward the electrode central portion.

### (Technique 3)

The electrode for secondary batteries according to Technique 1 or 2, wherein elongations at break of the first electrode edge portion and the second electrode edge portion each are 5% or more.

### (Technique 4)

The electrode for secondary batteries according to any one of Techniques 1 to 3, wherein widths of the first electrode edge portion and the second electrode edge portion each are 8 mm or more and 12 mm or less.

### (Technique 5)

The electrode for secondary batteries according to any one of Techniques 1 to 4, wherein the electrode current collector is an aluminum foil or an aluminum alloy foil.

### (Technique 6)

A secondary battery including:
a power generation element,
wherein the power generation element includes paired electrodes, a separator, and an electrolyte,
the paired electrodes are wound with the separator therebetween, and
at least one of the paired electrodes is the electrode for secondary batteries according to any one of techniques 1 to 4.

### (Technique 7)

The secondary battery according to Technique 6, further including
a metal case in a form of a bottomed cylinder that houses the power generating element,
wherein an outer diameter of the metal case is 25 mm or more.

Hereinafter, the present disclosure will be specifically described based on examples and comparative examples, but the present disclosure is not limited to the following examples.

### Examples 1 to 3 and Comparative Example 2

In the following, secondary batteries each having a wound electrode group were produced, and a positive electrode of the electrode group was evaluated.

### [Positive Electrode Production]

A positive electrode slurry was obtained by adding an appropriate amount of NMP to a positive electrode mixture. As the positive electrode mixture, a mixture of a lithium-containing composite oxide being a positive electrode active material, carbon black being a conductive aid, and polyvinylidene fluoride (PVDF) being a binder was used. LiNi_{0.8}Co_{0.1}Mn_{0.1}O₂ was used as the lithium-containing composite oxide. In the positive electrode mixture, the mass ratio of the lithium-containing composite oxide, the carbon black, and the PVDF was set to 98:1:1.

The positive electrode slurry was applied to both surfaces of an aluminum foil (15 μm in thickness) being a positive electrode current collector, and the resulting coated film was dried and rolled to form a positive electrode mixture layer. Thus, a positive electrode as illustrated in FIG. 2 was obtained. Specifically, the positive electrode slurry was intermittently applied with a predetermined thickness to one edge of the aluminum foil in the short-side direction, along the long-side direction of the positive electrode current collector, dried, and rolled to form a first positive electrode edge portion having a first positive electrode mixture portion. The exposed portion of the positive electrode current collector was provided at eight locations in the first positive electrode edge portion. The positive electrode slurry was applied with a predetermined thickness to a part of the positive electrode current collector other than the first positive electrode edge portion, dried, and rolled to form a positive electrode main portion. The positive electrode main portion includes a second positive electrode edge portion having a second positive electrode mixture portion and a positive electrode central portion having a third positive electrode mixture portion.

Thereafter, only the first positive electrode edge portion and the second positive electrode edge portion were passed between the pair of heating rollers for heat treatment. The tensile strengths and the elongations at break of the first positive electrode edge portion and the second positive electrode edge portion were set to the values of the tensile strength and elongations at break for the positive electrode edge portions shown in Table 1 by appropriately adjusting the heat treatment temperature. The tensile strengths and the elongations at break were determined by the methods described above. The tensile strength of the positive electrode central portion, which has not been subjected to the heat treatment, was 180 MPa.

Thereafter, a positive electrode lead was attached at each location on the exposed portion of the positive electrode current collector provided in the first positive electrode edge portion. The width of the positive electrode (length in the short-side direction) was 65 mm. The widths of the first positive electrode edge portion and the second positive electrode edge portion were each set to 10 mm. The width of the positive electrode central portion was set to 45 mm.

### [Negative Electrode Production]

A negative electrode slurry was obtained by adding an appropriate amount of water to a negative electrode mixture. As the negative electrode mixture, a mixture of graphite being a negative electrode active material, styrene-butadiene copolymer rubber (SBR) being a binder, and carboxymethylcellulose (CMC) being a thickener was used. In the negative electrode mixture, the mass ratio of the graphite, the SBR, and the CMC was set to 98:1:1.

The negative electrode slurry was applied to both surfaces of a copper foil (8 μm in thickness) being a negative electrode current collector, and the resulting coated film was dried and rolled to form a negative electrode mixture layer. Thus, a negative electrode as illustrated in FIG. 3 was obtained. Specifically, the negative electrode slurry was applied to one edge of the copper foil in the short-side direction, along the long-side direction of the negative electrode current collector, dried, and rolled to form a negative electrode main portion having a negative electrode mixture portion. Apart of the other edge of the negative electrode current collector was left as an exposed portion.

### [Electrode Group Production]

In an inert gas atmosphere, one of the positive electrodes and the negative electrode were wound through a separator (a microporous film made of polyethylene) to produce an electrode group. The positive electrode and the negative electrode were arranged such that the first positive electrode edge portion was positioned at one of the edges of the electrode group and the exposed portion of the negative electrode current collector was positioned at the other edge of the electrode group.

### [Electrolyte Preparation]

An electrolyte was prepared by adding vinylene carbonate (VC) to a nonaqueous solvent obtained by mixing ethylene carbonate (EC) and dimethyl carbonate (DMC) in a volume ratio of 1:3, and dissolving LiPF₆. The content of VC in the entirety of the electrolyte was set to 5% by mass. The concentration of LiPF₆ in the electrolyte was set to 1.5 mol/L.

[Secondary Battery Production]

One of the electrode groups and the electrolyte were used to complete a cylindrical lithium-ion secondary battery as illustrated in FIG. 1. The plurality of positive electrode leads were bundled and electrically connected to a first portion of a first terminal member. The exposed portion of the negative electrode current collector was connected to an end face current collector plate by laser welding, and the end face current collector plate was electrically connected to a negative electrode current collector plate via a connecting plate.

In Table 1, A1 to A3 represent batteries of Examples 1 to 3, respectively, and B2 represents a battery of Comparative Example 2.

### Comparative Example 1

A battery B1 of Comparative Example 1 was produced in the same manner as the battery A1 of Example 1, except that the heat treatment was not performed on the first positive electrode edge portion and the second positive electrode edge portion in the positive electrode production.

### Comparative Examples 3 to 5

In the positive electrode production, heat treatment using heating rollers was performed on the first positive electrode edge portion, the second positive electrode edge portion, and the positive electrode central portion. The tensile strengths of the first positive electrode edge portion, the second positive electrode edge portion, and the positive electrode central portion were set to those shown in Table 1 by adjusting the heat treatment temperature.

Batteries B3 to 5 of Comparative Examples 3 to 5 were produced in the same manner as the battery A1 of Example 1 except for the above.

### [Evaluation]

### (Positive Electrode Breakage Rate in Electrode Group Production (Winding))

For each of Examples and each of Comparative Examples, 100 electrode groups were produced. In the production, the rate (percentage) of the number of positive electrodes broken at the time of the electrode group production out of the 100 positive electrodes was determined as a positive electrode breakage rate.

(Positive Electrode Dimensional Change after Charge/Discharge Cycles)

For each of Examples and each of Comparative examples, 10 secondary batteries were produced with electrode groups each including one of the positive electrodes and the negative electrode, neither of which was broken in the winding. Each of the secondary batteries was charged at a constant current of 0.2 C in an environment at a temperature of 25° C. Once the battery voltage reached 4.2 V, the secondary battery was charged at a constant voltage until the charge current reached 0.02 C. After a 10-minute pause, constant current discharging at 0.2 C was performed until the battery voltage reached 2.5 V The charging and discharging as above were repeated for 300 cycles.

CT images of the longitudinal sections of the secondary batteries (axial sections of electrode groups) after the charge/discharge cycles were obtained and the length of each positive electrode in the short-side direction was determined. A value (mm) obtained by subtracting the initial length of the positive electrode in the short-side direction from the length of the positive electrode in the short-side direction after the charge/discharge cycles was determined as a positive electrode dimensional change. The positive electrode dimensional change is the average value for the 10 secondary batteries.

The evaluation results are shown in Table 1. Table 1 also shows the elongations at break of the positive electrode edge portions.

TABLE 1

| | | | Elongation | | | | Positive |
|---|---|---|---|---|---|---|---|
| | Tensile strength | | at break of | Width of | Width of | Positive | electrode |
| | (MPa) | | positive | positive | positive | electrode | dimensional |
| | Positive | Positive | electrode | electrode | electrode | breakage | change after |
| | electrode | electrode | edge | edge | central | rate in | charge/discharge |
| Secondary | edge | central | portions | portions | portion | winding | cycles |
| battery | portions | portion | (%) | (mm) | (mm) | (%) | (mm) |
| A2 | 70 | 180 | 8.4 | 10 | 45 | 0 | 0.21 |
| A1 | 80 | 180 | 6.1 | 10 | 45 | 0 | 0.20 |
| A3 | 95 | 180 | 4.0 | 10 | 45 | 2 | 0.15 |
| B1 | 180 | 180 | 2.2 | 10 | 45 | 60 | 0.08 |
| B2 | 140 | 180 | 1.8 | 10 | 45 | 50 | 0.12 |
| B3 | 90 | 90 | 6.2 | 10 | 45 | 0 | 2.00 |
| B4 | 100 | 100 | 3.0 | 10 | 45 | 10 | 1.90 |
| B5 | 80 | 135 | 6.0 | 10 | 45 | 0 | 1.00 |

In the batteries A1 to A5 each having a tensile strength of the positive electrode edge portions of 100 MPa or less, breakage of the positive electrode in the winding was suppressed. In addition, positive electrode dimensional change in the charge/discharge cycles was suppressed in the batteries A1 to A5 each having a tensile strength of the positive electrode central portions of 150 MPa or more.

In the batteries B1 and B2 each having a tensile strength of the positive electrode edge portions of larger than 100 MPa, the positive electrode breakage rate in the winding increased. The positive electrode dimensional change in the charge/discharge cycles increased in the batteries B3 to B5 each having a tensile strength of the positive electrode central portions of less than 150 MPa.

### Examples 4 and 5

In the positive electrode production, the widths of the first positive electrode edge portion and the second positive electrode edge portion were set to the width values for the positive electrode edge portions listed in Table 1. The width of the positive electrode central portion was set to those listed in Table 1. Batteries A4 and A5 of Examples 4 and 5 were produced and evaluated in the same manner as the battery A1 of Example 1 except for the above. The evaluation results are shown in Table 2. Table 2 also shows the results of the secondary battery A1.

TABLE 2

| | | | Elongation | | | | Positive |
|---|---|---|---|---|---|---|---|
| | Tensile strength | | at break of | Width of | Width of | Positive | electrode |
| | (MPa) | | positive | positive | positive | electrode | dimensional |
| | Positive | Positive | electrode | electrode | electrode | breakage | change after |
| | electrode | electrode | edge | edge | central | rate in | charge/discharge |
| Secondary | edge | central | portions | portions | portion | winding | cycles |
| battery | portions | portion | (%) | (mm) | (mm) | (%) | (mm) |
| A5 | 80 | 180 | 5.8 | 5 | 55 | 3 | 0.18 |
| A1 | 80 | 180 | 6.1 | 10 | 45 | 0 | 0.20 |
| A4 | 80 | 180 | 5.8 | 15 | 35 | 0 | 0.43 |

In all of the secondary batteries A1, A4, and A5, breakage of the positive electrode in the winding was suppressed, and positive electrode dimensional change in the charge/discharge cycles was suppressed. Particularly favorable results were obtained in the secondary battery A1 including positive electrode edge portions (first positive electrode edge portion and second positive electrode edge portion) each having a width in the range from 8 to 12 mm.

### INDUSTRIAL APPLICABILITY

The secondary battery according to the present disclosure is useful as a main power source for a mobile communication device, a portable electronic device, or an electric vehicle, for example.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

10: Secondary battery
11: Case
   12: Through hole
   13: Recess
14: Electrode group
16: Positive electrode terminal
   17: First terminal member (terminal member)
      17a: First portion
      17b: Second portion
      17c: Third portion
   18: Second terminal member
19: End face current collector plate
21: Connecting plate
22: Negative electrode current collector plate
   22a: Injection hole
23: Sealing plate
24: Insulating member
25: Insulating plate
26: Positive electrode gasket
27: Negative electrode gasket
LM: Laser mark
110: Positive electrode
   110a: One edge
   110b: Other edge
   112: Positive electrode lead
   112a: Folded portion
   113: First positive electrode edge portion
   113a: Positive electrode central-side edge
   113b: Exposed portion of positive electrode current collector
   113c: First positive electrode mixture portion
   114: Second positive electrode edge portion
   114a: Positive electrode central-side edge
   114c: Second positive electrode mixture portion
   115: Positive electrode central portion
   115c: Third positive electrode mixture portion
120: Negative electrode
   120a: One edge
   120b: Other edge
   123: Negative electrode edge portion
   123a: Negative electrode center-side edge
   123b: Exposed portion of negative electrode current collector
   123c: First negative electrode mixture portion
   124: Negative electrode main portion
   124c: Second negative electrode mixture portion

1. An electrode for secondary batteries, comprising:
an electrode current collector having a band shape; and an electrode mixture layer provided on the electrode current collector,
wherein the electrode has a first electrode edge portion including one edge of the electrode in a short-side direction, a second electrode edge portion including another edge of the electrode in the short-side direction, and an electrode central portion other than the first electrode edge portion and the second electrode edge portion,
tensile strengths of the first electrode edge portion and the second electrode edge portion each are 100 MPa or less, and
a tensile strength of the electrode central portion is 150 MPa or more.

2. The electrode for secondary batteries according to claim 1,
wherein the first electrode edge portion or the second electrode edge portion has an exposed portion of the electrode current collector intermittently provided at a plurality of locations along a long-side direction of the electrode, and
the exposed portion is provided from one edge or the other edge of the electrode in the short-side direction toward the electrode central portion.

3. The electrode for secondary batteries according to claim 1,
wherein elongations at break of the first electrode edge portion and the second electrode edge portion each are 5% or more.

4. The electrode for secondary batteries according to claim 1,
wherein widths of the first electrode edge portion and the second electrode edge portion each are 8 mm or more and 12 mm or less.

5. The electrode for secondary batteries according to claim 1,
wherein the electrode current collector is an aluminum foil or an aluminum alloy foil.

6. A secondary battery comprising
a power generation element,
wherein the power generation element includes paired electrodes, a separator, and an electrolyte,
the paired electrodes are wound with the separator therebetween, and
at least one of the paired electrodes is the electrode for secondary batteries according to claim 1.

7. The secondary battery according to claim 6, further comprising
a metal case in a form of a bottomed cylinder that houses the power generating element,
wherein an outer diameter of the metal case is 25 mm or more.
